(19) United States
(12) Patent Application Publication
(10) Pub. No.: US 2017/0346930 A1
(43) Pub. Date: Nov. 30, 2017

(54) INTELLIGENT HARDWARE-ASSISTED ICMP REQUEST PROCESSING

(71) Applicant: Brocade Communications Systems, Inc., San Jose, CA (US)

(72) Inventors: Wilson Jacob, Santa Clara, CA (US); Sam Moy, Millbrae, CA (US); David Wang, San Jose, CA (US); Sanjeev Chhabria, Castro Valley, CA (US); Suneetha Sarala, Fremont, CA (US)

(21) Appl. No.: 15/607,030

(22) Filed: May 26, 2017

Related U.S. Application Data
(60) Provisional application No. 62/342,729, filed on May 27, 2016.

(51) Int. Cl. H04L 29/06; H04L 29/12

(52) U.S. Cl. CPC H04L 69/163; H04L 69/12; H04L 61/60; H04L 69/16

(57) ABSTRACT

Techniques for implementing intelligent hardware assisted ICMP request processing in a network device are provided. According to one embodiment, the network device can receive an ICMP request packet and write the packet to a protocol buffer configured to queue packets for processing by a management CPU. When the ICMP request packet is ready to be processed by the management CPU, a hardware-based ICMP request handler of the network device can determine whether the ICMP request packet matches any entries in an ICMP table. If the ICMP request packet does match an entry in the ICMP table, the ICMP request handler can generate an ICMP response packet for replying to the ICMP request packet, without sending the ICMP request packet to the management CPU.

### CROSS-REFERENCES TO RELATED APPLICATIONS

The present application claims the benefit and priority of U.S. Provisional Application No. 62/342,729, filed May 27, 2016, entitled “INTELLIGENT HARDWARE ASSISTANCE FOR SINGLE-THREADED SINGLE-CORE NETWORKING DEVICES TO PROVIDE TIMELY RESPONSE TO ICMP REQUESTS.” The entire contents of this application are incorporated herein by reference in its entirety for all purposes.

### BACKGROUND

Internet Control Message Protocol (ICMP) is a supporting protocol in the TCP/IP protocol suite that is commonly used to test the health/reachability of hosts and network devices in an IP network. For example, when a network operator suspects that a network device such as a switch or router is experiencing a problem, the network operator will typically send, via the “ping” software utility, one or more ICMP requests (also referred to herein as “ping requests”) to the network device. If the network device is healthy, the network device is expected to send, in reply to the ICMP requests, ICMP responses (i.e., ping responses) back to the network operator within a particular timeframe. There are three possible outcomes: (1) no ICMP response is received from the network device; (2) an ICMP response is received, but the response time (i.e., latency) is longer than expected; or (3) an ICMP response is received within the expected timeframe. Of these three outcomes, (1) and (2) are generally interpreted as indicators that the network device (or a network path leading to the network device) is experiencing a problem that needs to be addressed.

In a conventional network device that comprise a single-threaded, single-core management CPU, there are two limitations that can affect the timeliness of its ICMP request processing. First, such conventional network devices generally process ICMP requests in software on their respective management CPUs, rather than in hardware via custom silicon. Second, such conventional network devices generally assign a lower processing priority to ICMP requests (which are considered diagnostic packets) than packets of essential routing protocols such as Open Shortest Path First (OSPF) and Border Gateway Protocol (BGP). These two limitations can result in scenarios where the network device exhibits a relative high ping response time/latency, even when the network device is functioning normally (i.e., is healthy). This is because the network device's single-threaded, single-core management CPU may be busy with other tasks at the time an ICMP request is received, resulting in a delay in generating and sending out an ICMP response. These limitations can also result in scenarios where the network device exhibits variable ping response times/latencies. This is because the amount of time the network device will take to respond to a given ICMP request will depend on the other tasks queued for the management CPU and their priorities at the time the request is received. These issues can cause a network operator that initiates a ping on the network device to obtain a potentially inaccurate view of the health of the network device and/or network.

One way in which network vendors have attempted to address the foregoing issues is to increase the processing priority of ICMP requests relative to other packets. With this approach, if an ICMP request is queued and awaiting management CPU processing, the ICMP request will be processed before other queued packets. However, in a single-threaded, single-core network device, increasing ICMP packet priority does not have any effect in a case where the management CPU is already busy with an in-progress task at the time an ICMP request is received. In this case, the ICMP request will still need to wait for the management CPU to finish its in-progress task before the request can be processed, resulting in a potentially long and/or variable ping response time.

Another way in which network vendors have attempted to address the foregoing issues is to implement hardware acceleration in the packet processor of the network device. With this approach, an entry is programmed into the packet processor for responding to ICMP requests. Thus, the ICMP requests are never routed to the device's management CPU for handling; instead, they are processed entirely in hardware at the packet processor level, resulting in low and consistent ping response latency. However, a significant problem with this approach is that the ICMP responses may no longer reflect the true health status of the network device. For example, consider a scenario where the management CPU of the network device (or the software running on the management CPU) becomes nonresponsive. In this scenario, since ICMP requests are handled entirely by the packet processor, the network device will continue to send out timely ICMP responses in reply to ICMP requests, even though the control plane of the device is nonfunctional. This will give the false impression that the network device is healthy when in fact it is not. Additionally, this particular hardware-based approach cannot support asymmetric routing, Equal Cost Multiple Path (ECMP) routes, VRF (Virtual Routing and Forwarding) instances, or LAG interfaces/ECMP over LAG.

### SUMMARY

Techniques for implementing intelligent hardware assisted ICMP request processing in a network device are provided. According to one embodiment, the network device can receive an ICMP request packet and write the packet to a protocol buffer configured to queue packets for processing by a management CPU. When the ICMP request packet is ready to be processed by the management CPU, a hardware-based ICMP request handler of the network device can determine whether the ICMP request packet matches any entries in an ICMP table. If the ICMP request packet does match an entry in the ICMP table, the ICMP request handler can generate an ICMP response packet for replying to the ICMP request packet, without sending the ICMP request packet to the management CPU.

The following detailed description and accompanying drawings provide a better understanding of the nature and advantages of particular embodiments.

### BRIEF DESCRIPTION OF DRAWINGS

FIG. 1 depicts a component architecture of a network device and an ICMP request processing flow within the network device.

FIG. 2 depicts a component architecture of a network device that supports intelligent hardware-assisted ICMP request processing according to an embodiment.

FIGS. 3A and 3B depict an ICMP request processing flow within the network device of FIG. 2 according to an embodiment.

FIG. 4 depicts an ICMP request processing flowchart that may be executed by the network device of FIG. 2 according to an embodiment.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details, or can be practiced with modifications or equivalents thereof.

### 1. Overview

Embodiments of the present disclosure provide intelligent hardware-assisted (i.e., hybrid software/hardware) techniques for implementing ICMP request processing in a network device that allow for low and consistent ICMP response latency when the network device is healthy, while at the same time ensuring that the ICMP responses generated by the network device accurately reflect its health status. For example, in cases where the management CPU of the network device becomes overloaded, ICMP responses will become delayed or dropped, thereby indicating to a network operator that the device is experiencing a problem that should be addressed. In certain embodiments, these techniques can also support asymmetric routing, ECMP routes, LAG interfaces/ECMP over LAG, and be VRF aware. Thus the techniques of the present disclosure overcome the problems associated with pure software-based ICMP request processing (i.e., high and variable response latency), while also avoiding the drawbacks of conventional hardware-based ping response solutions (i.e., difficulty in reflecting the true health status of the device and lack of support for VRF, asymmetric routing, ECMP, etc.).

A detailed discussion of various embodiments is provided in the sections that follow.

Certain examples and embodiments are discussed in the context of single-threaded, single-core network devices, since such devices are most likely to benefit from the advantages offered by the techniques described herein. However, it should be appreciated that the hardware-assisted techniques of the present disclosure are not solely limited to such single-threaded, single-core network devices, and instead may be broadly applied to any type of network device or system of devices that performs ICMP request processing.

### 2. Device Architecture and Conventional ICMP Request Processing Flow

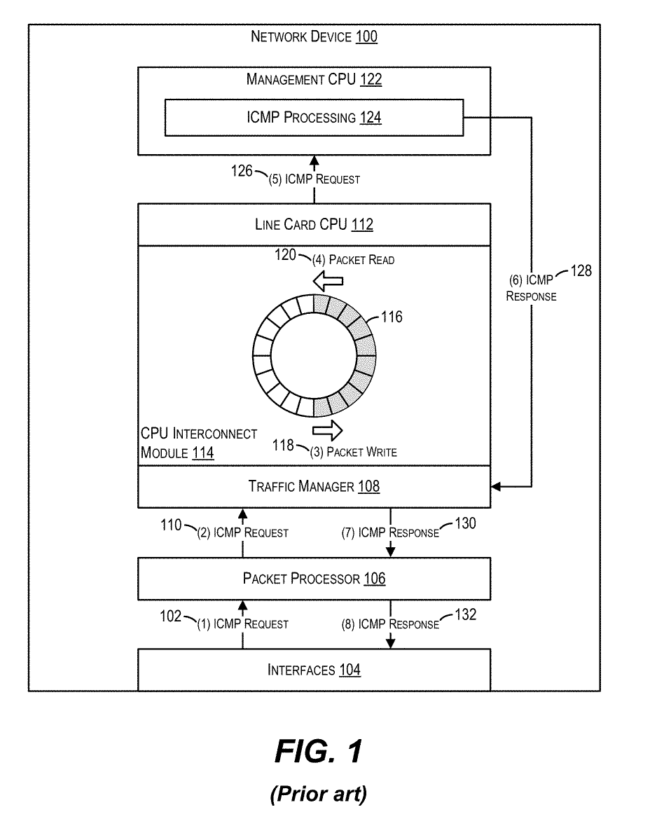

FIG. 1 depicts a component architecture of an example network device (e.g., switch or router) 100 and a conventional ICMP request processing flow within device 100. At step (1) (reference numeral 102), an ICMP request packet that is received on an interface 104 of network device 100 is passed to a packet processor 106. Packet processor 106 forwards the ICMP request to a traffic manager 108 (step (2), reference numeral 110), which queues the request packet in one or more internal queues for protocol processing. Traffic manager 108 then transfers the ICMP request to a line card CPU 112 through a CPU interconnect module 114 comprising a protocol ring buffer 116.

In particular, the ICMP request is written to protocol ring buffer 116 (step (3), reference numeral 118), which is read by line card CPU 112 in first-in first-out (FIFO) order. When the ICMP request reaches the end of protocol ring buffer 116 (in other words, when the ICMP request is the oldest packet in the buffer), line card CPU 112 reads the request packet from the buffer (step (4), reference numeral 120). Line card CPU 112 then redirects the ICMP request to a management CPU 122 (step (5), reference numeral 126). Management CPU 122 processes the ICMP request in software (via an IMCP processing module 124) and generates an ICMP response. Management CPU 122 then sends the generated ICMP response to traffic manager 108 (step (6), reference numeral 128), which forwards the ICMP response through packet processor 106 and an egress interface 104 towards its intended destination (steps (7) and (8), reference numerals 130 and 132).

As noted in the Background section, the main problem with the software-based ICMP processing flow shown in FIG. 1 is that it can result is long and unpredictable response latencies. This is particularly true if management CPU 122 is a single-threaded, single-core CPU, since in this case management CPU 122 can easily get backed up with other tasks that potentially have higher priorities than incoming ICMP requests, thereby causing processing of those requests (and thus the generation of corresponding ICMP responses) to be delayed or even skipped entirely.

There are certain known workarounds to the foregoing problem, such as implementing hardware accelerated ICMP request processing in packet processor 106. However, since this hardware accelerated approach completely bypasses the control plane of network device 100, it can result in inaccurate ICMP responses (i.e., ICMP responses that are sent out in a timely manner even though management CPU 122 has become nonresponsive), which in turn can mislead the network operator with respect to the true health status of network device 100.

### 2. Enhanced Device Architecture and Hardware-Assisted ICMP Request Processing Flow

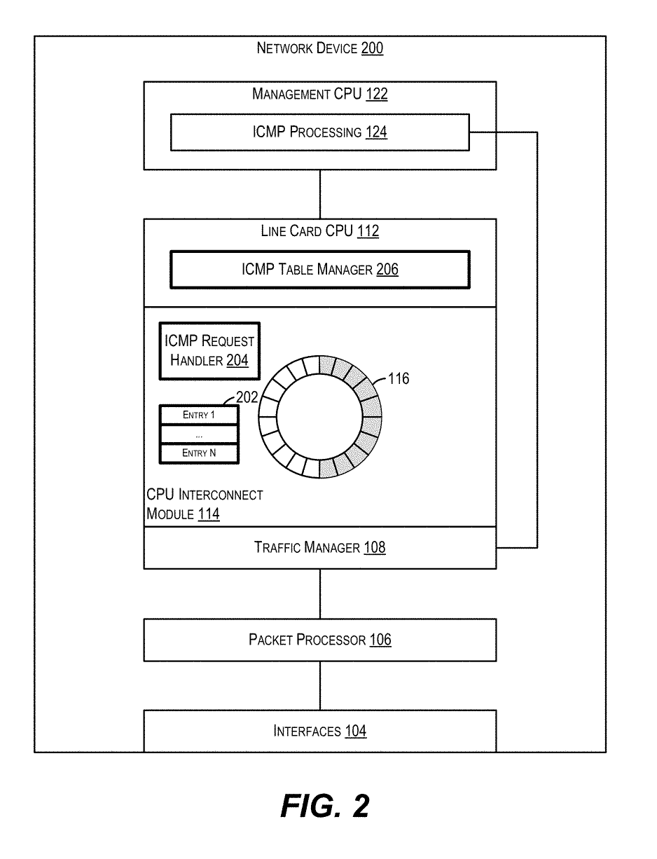

To address the issues mentioned above, FIG. 2 depicts an enhanced version of network device 100 (i.e., device 200) that includes a novel ICMP table 202 and ICMP request handler 204 in CPU interconnect module 114 and a novel ICMP table manager 206 in line card CPU 112. Generally speaking, ICMP table 202 and ICMP request handler 204 can be implemented in hardware, while ICMP table manager 206 can be implemented in software running on line card CPU 112.

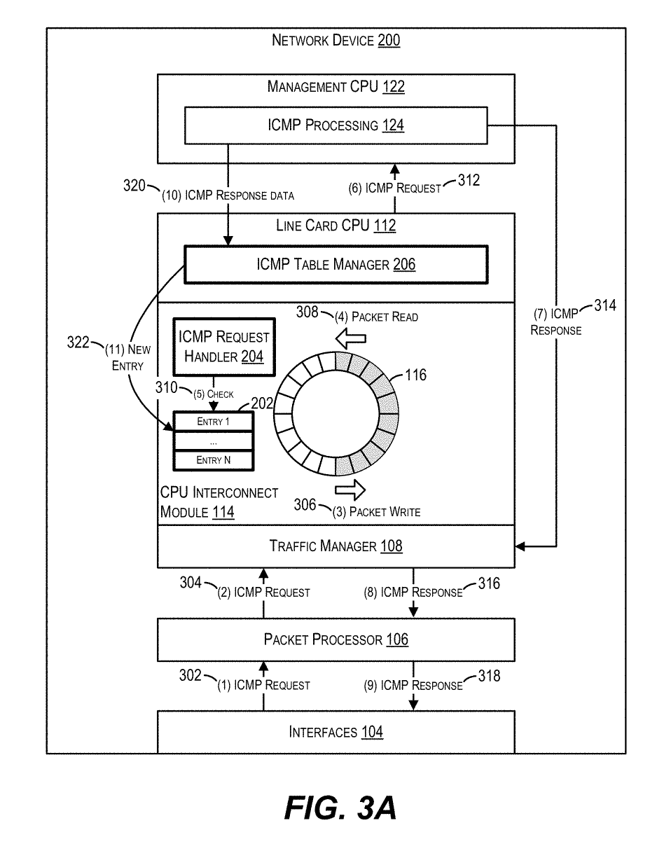

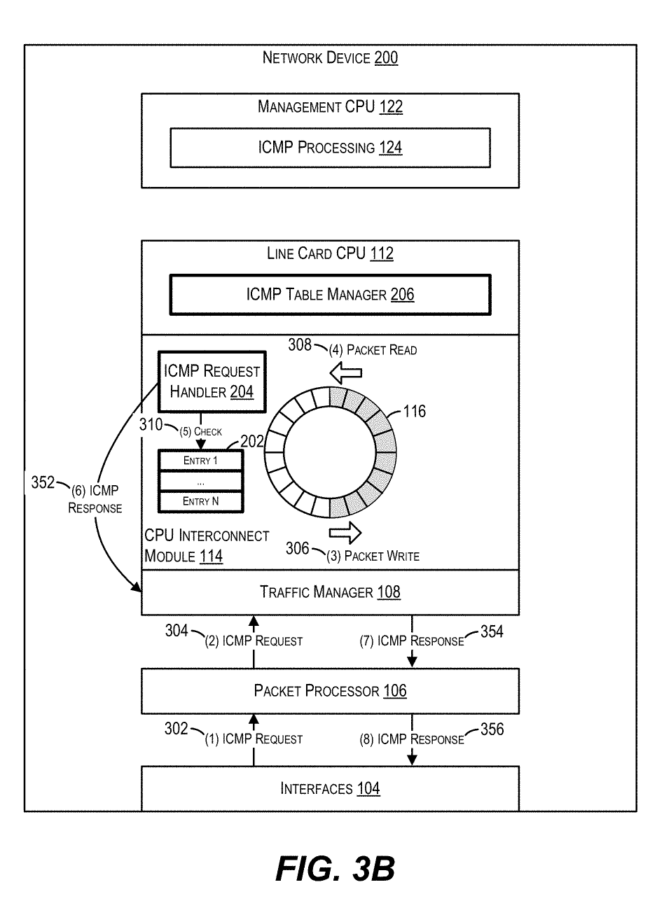

Further, FIGS. 3A and 3B depict a flow that illustrate how network device 200 can leverage new components 202, 204, and 206 to implement intelligent hardware-assisted ICMP request processing according to an embodiment. Starting with steps (1) and (2) (reference numerals 302 and 304) of FIG. 3A, an ICMP request packet that is received on an interface 104 of network device 200 can be passed to packet processor 106, and packet processor 106 can forward the ICMP request to traffic manager 108 for queuing. Further, at step (3) (reference numeral 306), CPU interconnect module 114 can write the ICMP request to protocol ring buffer 116 for protocol processing by line card CPU 112.

However, unlike the processing flow of FIG. 1, when the ICMP request reaches the end of protocol ring buffer 116, ICMP request handler 204 can read the request packet from buffer 116 and perform a check to determine whether there is an entry for the ICMP request in ICMP table 202 (steps (4) and (5), reference numerals 308 and 310). This check can entail determining whether any entry in ICMP table matches certain header fields of the request packet (e.g., a 5-tuple comprising source IP address, destination IP address, source port, destination port VLAN ID).

If there is no match at step (5), ICMP request handler 204 can pass the ICMP request to line card CPU 112, which in turn can redirect the request to management CPU 122 (step (6), reference numeral 312). Management CPU 122 can then process the ICMP request via IMCP processing module 124 and generate an ICMP response, which is sent through traffic manager 108, packet processor 106, and an egress interface 104 towards its intended destination (steps (7), (8), and (9), reference numerals 314, 316, and 318).

In addition, management CPU 122 can send data pertaining to the generated ICMP response to ICMP table manager 206 (step (10), reference numeral 320), which can create a new table entry in ICMP table 120 comprising the received data (and keyed according to the 5-tuple mentioned above) (step (11), reference numeral 322).

On the other hand, if a match is found at step (5) of FIG. 3A, processing can proceed as shown in FIG. 3B. In particular, at step (6) of FIG. 3B (reference numeral 352), ICMP request handler 204 can directly generate an ICMP response based on the data included in the matched table entry and send the generated response to traffic manager 108. The ICMP response can then be forwarded through packet processor 106 and an egress interface 104 towards its intended destination (steps (7) and (8), reference numerals 354 and 356). In this way, ICMP request handler 204 can process the request in a consistent and low latency manner, without involving management CPU 122.

With the general flow described above and shown in FIGS. 3A and 3B, network device 200 can advantageously respond to ICMP requests in a timely and consistent fashion in scenarios where the device is healthy, starting with the second request received from a given source. This is because after the first request (which in processed in software by management CPU 122), ICMP request handler 204 will have access to the data it needs (in ICMP table 202) to generate, in hardware, ICMP responses in reply to further ICMP requests originating from that source.

At the same time, if line card CPU 112 or management CPU 122 become nonresponsive or overloaded, they will stop de-queueing packets from protocol ring buffer 116 for some period of time. This will cause ICMP request handler 204 to receive the ICMP request more slowly than it typically would, and thus increase the latency for generating and sending out an ICMP response. Accordingly, with this approach, ICMP responses will be delayed if the device's CPU(s) are in a bad state, thereby allowing a network operator to obtain an accurate picture of the device's health via ping requests. This is in contrast to the hardware-accelerated approach described previously, in which ping responses are always sent out in a consistent and low latency manner regardless of the health of the network device's CPU(s).

### 3. Hardware-Assisted ICMP Request Processing Flowchart

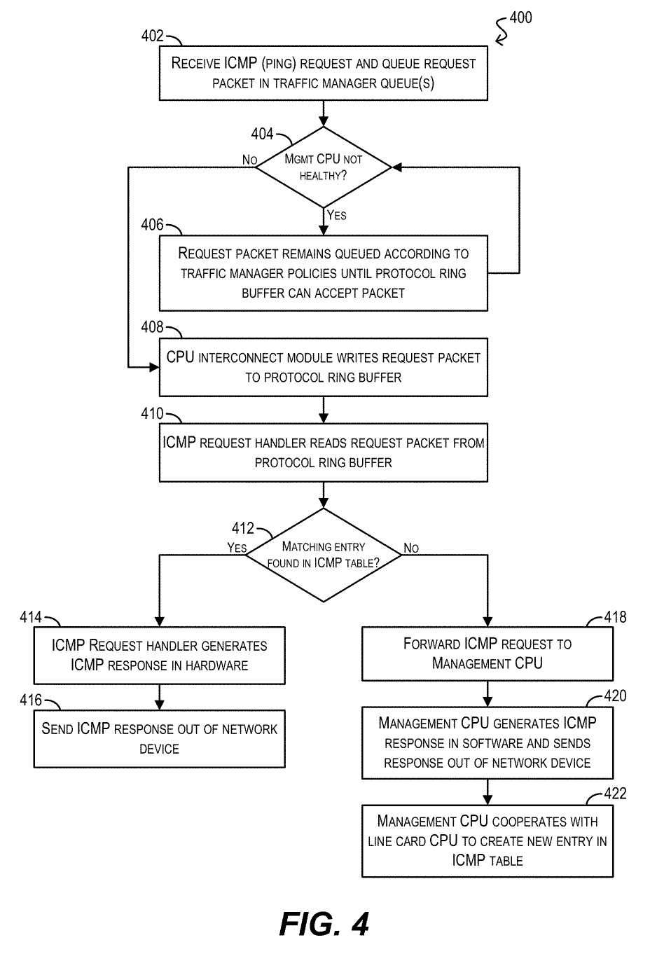

To further clarify the processing flow described with respect to FIGS. 3A and 3B, FIG. 4 depicts a flowchart 400 of this flow according to an embodiment. Starting with block 402, network device 200 can receive an ICMP (ping) request and queue the request packet in its traffic manager queue(s). If the device's management CPU 122 is not healthy (in other words, if protocol ring buffer 116 is full), the ICMP request can remained queued according to the policies of traffic manager 108 until protocol ring buffer 116 can accept the request packet (blocks 404 and 406).

On the other hand, if management CPU 122 is determined to be healthy at block 404, CPU interconnect module 114 can write the ICMP request to protocol ring buffer 116 (block 408) and ICMP request handler 204 can subsequently de-queue the request from buffer 116 (block 410).

At block 412, ICMP request handler 204 can check whether there is a matching entry for the current ICMP request in ICMP table 202. As mentioned previously, this check can involve determining whether there is any entry in ICMP table 202 that is keyed by the source IP address, destination IP address, source port, destination port, and VLAN ID parameters found in the request packet. If a match is found, ICMP request handler 204 can generate an ICMP response in hardware based on the data in the matched table entry and send the ICMP response out of the network device (blocks 414 and 416).

If no match is found at block 412, the ICMP request can be forwarded to management CPU 122 (block 418). At block 420, management CPU 122 can generate an ICMP response in software and send the ICMP response out of the network device. Further, at block 422, management CPU 122 can cooperate with line card CPU 112 to create a new entry in ICMP table 202 with data pertaining to the generated ICMP response. In this way, ICMP request handler 204 will have this data available in order to process future ICMP requests received from the same source without involving management CPU 122.

The above description illustrates various embodiments of the present disclosure along with examples of how aspects of the present disclosure may be implemented. The above examples and embodiments should not be deemed to be the only embodiments, and are presented to illustrate the flexibility and advantages of the present disclosure as defined by the following claims. For example, although certain embodiments have been described with respect to particular process flows and steps, it should be apparent to those skilled in the art that the scope of the present invention is not strictly limited to the described flows and steps. Steps described as sequential may be executed in parallel, order of steps may be varied, and steps may be modified, combined, added, or omitted. As another example, although certain embodiments have been described using a particular combination of hardware and software, it should be recognized that other combinations of hardware and software are possible, and that specific operations described as being implemented in software can also be implemented in hardware and vice versa.

The specification and drawings are, accordingly, to be regarded in an illustrative rather than restrictive sense. Other arrangements, embodiments, implementations and equivalents will be evident to those skilled in the art and may be employed without departing from the spirit and scope of the invention as set forth in the following claims.

What is claimed is:

1. A method comprising:
receiving, by a network device, an Internet Control Message Protocol (ICMP) request packet;
writing, by the network device, the ICMP request packet to a protocol buffer configured to queue packets for processing by a management central processing unit (CPU) of the network device;
when the ICMP request packet is ready to be processed by the management CPU, determining, by an ICMP request handler of the network device, whether the ICMP request packet matches any entries in an ICMP table; and
if the ICMP request packet matches an entry in the ICMP table, generating, by the ICMP request handler, an ICMP response packet for replying to the ICMP request packet, wherein the generating is performed without sending the ICMP request packet to the management CPU.

2. The method of claim 1 wherein the ICMP request handler is implemented in hardware on the network device.

3. The method of claim 1 wherein the ICMP request handler is implemented within a CPU interconnect module of the network device.

4. The method of claim 1 wherein the ICMP response packet is generated based on data included in the matched entry of the ICMP table.

5. The method of claim 1 wherein the writing of the ICMP request packet to the protocol buffer is delayed if the management CPU is overloaded.

6. The method of claim 1 wherein determining whether the ICMP request packet matches any entries in the ICMP table comprises matching one or more header fields of the ICMP request packet to corresponding key fields of the entries.

7. The method of claim 6 wherein the one or more header fields include source IP address, destination IP address, source port, destination port, and VLAN ID.

8. The method of claim 1 wherein, if the ICMP request packet does not match any entries in the ICMP table, the method further comprises:
forwarding the ICMP request packet to the management CPU; and
generating, by the management CPU, the ICMP response packet in software.

9. The method of claim 8 further comprising, subsequently to generating the ICMP response packet in software:
causing, by the management CPU, a new entry to be added to the ICMP table that corresponds to the ICMP request packet.

10. The method of claim 9 wherein the new entry includes data usable by the ICMP request handler for generating ICMP response packets in reply to future ICMP request packets received from a same source as the ICMP request packet.

11. A non-transitory computer readable storage medium having stored thereon program code executable by a network device, the program code causing the network device to:
receive an Internet Control Message Protocol (ICMP) request packet; and
write the ICMP request packet to a protocol buffer configured to queue packets for processing by a management central processing unit (CPU) of the network device,
wherein when the ICMP request packet is ready to be processed by the management CPU, an ICMP request handler of the network device attempts to match the ICMP request packet to entries in an ICMP table, and
wherein if the ICMP request packet matches an entry in the ICMP table, the ICMP request handler generates an ICMP response packet for replying to the ICMP request packet, without sending the ICMP request packet to the management CPU.

12. The non-transitory computer readable storage medium of claim 11 wherein the ICMP request handler is implemented in hardware on the network device.

13. The non-transitory computer readable storage medium of claim 11 wherein the writing of the ICMP request packet to the protocol buffer is delayed if the management CPU is overloaded.

14. The non-transitory computer readable storage medium of claim 11 wherein, if the ICMP request packet does not match any entries in the ICMP table, the ICMP request packet is forwarded to the management CPU, and wherein the management CPU generates the ICMP response packet in software.

15. The non-transitory computer readable storage medium of claim 14 wherein, subsequently to generating the ICMP response packet in software, the management CPU causes a new entry to be added to the ICMP table that corresponds to the ICMP request packet.

16. A network device comprising:
a management central processing unit (CPU);
an Internet Control Message Protocol (ICMP) request handler; and
an ICMP table,
wherein the network device:
receives an ICMP request packet;
writes the ICMP request packet to a protocol buffer configured to queue packets for processing by the management CPU;
when the ICMP request packet is ready to be processed by the management CPU, determines, via the ICMP request handler, whether the ICMP request packet matches any entries in an ICMP table; and
if the ICMP request packet matches an entry in the ICMP table, generates, via the ICMP request handler, an ICMP response packet for replying to the ICMP request packet, wherein the generating is performed without sending the ICMP request packet to the management CPU.

17. The network device of claim 16 wherein the network device is a network switch or a network router.

18. The network device of claim 16 wherein the writing of the ICMP request packet to the protocol buffer is delayed if the management CPU is overloaded.

19. The network device of claim 16 wherein, if the ICMP request packet does not match any entries in the ICMP table, the ICMP request packet is forwarded to the management CPU, and wherein the management CPU generates the ICMP response packet in software.

20. The network device of claim 19 wherein, subsequently to generating the ICMP response packet in software, the management CPU causes a new entry to be added to the ICMP table that corresponds to the ICMP request packet.
